(19) United States
(12) Patent Application Publication
(10) Pub. No.: US 2020/0162535 A1
(43) Pub. Date: May 21, 2020

(54) Methods and Apparatus for Learning Based Adaptive Real-time Streaming

(71) Applicants: Zhan Ma, Fremont, CA (US); Xu Zhang, Nanjing (CN); Hao Chen, Nanjing (CN)

(72) Inventors: Zhan Ma, Fremont, CA (US); Xu Zhang, Nanjing (CN); Hao Chen, Nanjing (CN)

(21) Appl. No.: 16/687,739

(22) Filed: Nov. 19, 2019

Related U.S. Application Data
(60) Provisional application No. 62/769,534, filed on Nov. 19, 2018.

(51) Int. Cl. H04L 29/06; H04L 12/26; G06N 3/08

(52) U.S. Cl. CPC H04L 65/607; H04L 65/608; G06N 3/08; H04L 65/80; H04L 43/0841; H04L 65/601

(57) ABSTRACT

This invention discloses a deep reinforcement learning based adaptive bitrate selection method and system for real-time streaming, where deep reinforcement learning neural networks are utilized to receive states observations and make bitrate decisions. Simulation is constructed to provide network states including network QoS and playback status to agents and compute accumulated rewards according to the bitrate actions made by agents. ARS balances a variety of QoE goals to determine the accumulated rewards. ARS also enables multiple agents to be trained concurrently and conducts training process in a simulation environment to accelerate the training speed. In addition, ARS supports training ABR algorithm both online and offline.

### CROSS-REFERENCE TO RELATED APPLICATIONS

This application claims priority to the following patent application, which is hereby incorporated by reference in its entirety for all purposes: U.S. Patent Provisional Application No. 62/769,534, filed on Nov. 19, 2018.

### TECHNICAL FIELD

This invention relates to adaptive real-time video streaming, particularly methods and systems using deep reinforcement learning for adaptive bitrate selection.

### BACKGROUND

In real-time video systems, such as video conferencing, cloud gaming, and virtual reality (VR), videos are encoded at the sender, and streamed over the Internet to the receiver. Since the network conditions across the Internet change dynamically, and vary noticeably among different end users, an adaptive bitrate (ABR) algorithm is usually deployed in such system to adapt sending bitrate to combat network dynamics.

Widely deployed ABR algorithms include for example GCC (Google Congestion Control) and BBR (Bottleneck Bandwidth and Round-trip propagation time). These existing ABR algorithms typically include congestion detection, slow start and quick recovery.

Due to the tight millisecond-level latency restriction for real-time video streaming, HTTP based video streaming systems (such as the HTTP Live Streaming (“HLS”) and Dynamic Adaptive Streaming over HTTP (“DASH”) protocols) with trunk-level granularity are not suited for performing real-time video streaming, because they need to prepare video segments in advance, which introduces at least another layer of delay. For this reason, the conventional buffer-based, rate-based or even learning-based ABR algorithms for HTTP protocols are not suited for low-delay/real-time video scenarios, such as cloud gaming and video conference.

In the conventional real-time streaming systems, after the video session is established, the streaming server (video server) first streams compressed video to a service gateway, which forwards the video stream to a client. The client periodically returns its playback status and current network Quality of Service (QoS) parameters to the service gateway. Using an existing adaptive bitrate (ABR) algorithm, the service gateway outputs a target bitrate to the streaming server for bitrate adaptation. The existing ABR algorithms use a variety of different inputs (e.g., playback status and network QoS parameters) to change the bitrate for future streaming. In this type of systems, the client playbacks the video frames instantly upon receipt to guarantee real-time interaction. To meet the low-latency requirement, the service gateway in the conventional real-time streaming systems would request the streaming server to force an Instantaneous Decoding Refresh (IDR) or Random Access frame to restart a new group of picture (GoP) over TCP, if no new frames are received over a certain time period. The policies produced by ABR algorithms heavily influence the video streaming performance. For real-time interaction scenarios, user's quality of experience (QoE) depends greatly on the video steaming performance.

The existing ABR algorithms face multiple challenges. For example, only network QoS parameters are considered in these algorithms to derive policies, which may fail to produce consistent user QoE. As an example, Google Congestion Control (GCC) only takes delay and packet loss rate into consideration to perform congestion control and bitrate adaptation, without considering other relevant factors such as user's QoS requirements.

Existing ABR algorithms also have no knowledge of the underlying network, so they are mainly heuristic algorithms and have difficulty in determining the optimal bitrate to avoid frame freezing and improve video quality. When there is no congestion, the bitrate is increased conservatively to achieve higher video quality. Once the bitrate is overly adjusted, the performance would decrease sharply from its peak. Then the bitrate would decrease to a significantly lower level and another round of conservative bitrate growth is triggered when the network condition is getting better. Since the existing algorithms (such as GCC) has no knowledge of the underlying network, it tends to be trapped in this vicious circle of bitrate adaption, resulting in a low QoE with network underutilization.

Deep Reinforcement Learning (DRL)-based ABR algorithm discussed herein overcomes these constraints of the conventional ABR algorithms, improves the bitrate adaption, user QoE, and network utilization, and offers advantageous solutions in the fields of information theory, game theory, automatic control, such as AlphaGo and cloud video gaming.

### BRIEF SUMMARY

The present invention relates to a deep reinforcement learning-based ABR algorithm, hereinafter referred to as Adaptive Real-time Streaming (ARS). ARS uses deep reinforcement learning tools to observe the features of the underlying network in real time. ABS learns to make subsequent ABR decisions automatically through observing the performance of past decisions, without using any pre-programmed control rules about the operating environment or heuristically probing the network. In one embodiment, the ARS system utilizes TCP or UDP to conduct an end-to-end process of streaming a real-time video (for example, gaming video). The ARS system includes a Streaming Server, a Forwarder, and a user end. This ARS system also includes an ARS Controller, which receives network/playback status, and performs the ABR algorithm. The user end sends the playback status to the Forwarder and the ARS Controller periodically. The ARS Controller in the service gateway uses ARS to determine the bitrate for the next chunk of video data and output the target bitrate to the streaming server for bitrate adaptation.

In one embodiment, the ARS system using UDP also includes and a Network Address Translation (NTA) module, which performs the transversal of UDP address in the phase of session establishment between the user end and the Forwarder.

In one embodiment, the ARS system using TCP also includes a Frame Buffer to manage the real-time video stream sent to the user end through the Forwarder.

In one embodiment, the ARS system employs reinforcement learning tools to train and optimize the ABR algorithm.

In one embodiment, each user end serves as an agent, which takes an action Aₜ (i.e., streaming at a certain bitrate) in the environment.

In another embodiment, two categories of states Sₜ including the network QoS and the playback status are provided to the agent from the environment. For example, the network QoS parameters comprise the round-trip time (RTT), the received bitrate, the packet loss rate, the retransmission packet count and so on. The play back status includes the received frame rate, the maximum received frame interval and the minimum received frame interval.

In another embodiment, the environment will provide a reward Rₜ to the agent, on which the agent is based to decide next action Aₜ₊₁ to keep increasing the reward Rₜ. The action frequency is confined to per second or GoP to enable fast reaction to network changes. This is supported by the fact that video encoding is operated in real time for real-time video streaming systems. The decision is made following a control policy, which is generated using a neural network. Hence, ARS does not need to use a network estimator, which is normally included in the conventional video streaming systems to estimate the bitrate for the next moment using ABR algorithms. ARS instead maps “raw” observations (i.e., states) to perform the bitrate adaptation through the neural network for the next ground (“ground” represents a bitrate adaptation event in the frequency of per second or GoP).

In a further embodiment, ARS balances a variety of QoE goals and determines the reward Rₜ, such as maximizing video quality (i.e., using highest average bitrate), minimizing video freezing events (i.e., minimizing scenarios where the received frame rate is less than the sending frame rate), maintaining video quality smoothness (i.e., avoiding frequent bitrate fluctuations), and minimizing video latency (i.e., achieving the minimum interactive delay).

In another embodiment, to accelerate the training speed, ARS enables multiple agents to train the ABR algorithms concurrently.

In another embodiment, ARS supports training of the ABR algorithms both online and offline.

In a further embodiment, to further accelerate the training speed, ABR algorithms are trained in a simulation environment offline that closely models the network dynamics of video streaming with real client applications.

In another embodiment, ARS supports a variety of different training algorithms (such as DQN (Deep Q-learning Network), REINFORCE, Q-learning and A3C (Asynchronous advantage actor-critic)) in the abstract reinforcement learning framework.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 is a diagram that illustrates an Adaptive Real-time Streaming system over UDP.

FIG. 2 is a diagram that illustrates an Adaptive Real-time Streaming system over TCP.

FIG. 3 is a diagram that illustrates an embodiment of training method for ABS algorithm in ARS.

FIG. 4 is a diagram that illustrates an embodiment of the actor-critic algorithm for generating ABR policies in ARS.

FIG. 5 is a diagram illustrating various components that may be utilized in an exemplary embodiment of the electronic devices wherein the exemplary embodiment of the present principles can be applied.

### DETAILED DESCRIPTION

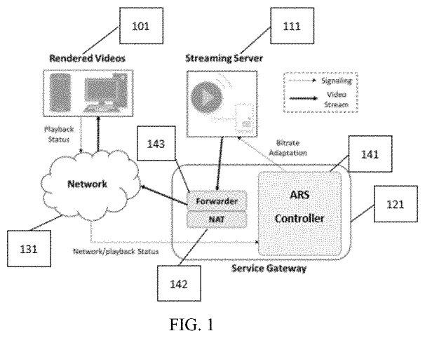

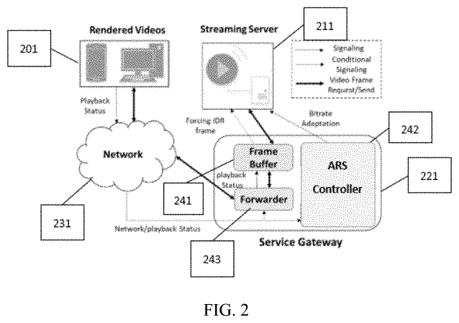

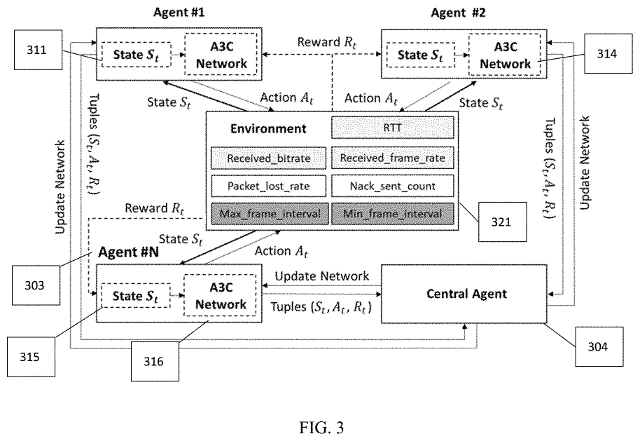

FIG. 1 illustrates an embodiment of an end-to-end process and system of streaming a real-time video using ARS over UDP. FIG. 2 illustrates an embodiment of an end-to-end process and system of streaming a real-time video using ARS over TCP. As shown in FIGS. 1 and 2, after the video session is established, a Streaming Server (video server) 111/211 first streams a compressed video to a Service Gateway 121/221, which is responsible to forward the video stream to a user end 101/201 through the Network 131/231. The user end 101/201 periodically returns its playback status and current network Quality of Service (QoS) parameters to the Service Gateway 121/221. The Service Gateway 121/221 includes a Forwarder 143/243 and an ARS Controller 141/242. The Streaming Server 111/211 transforms videos to be streamed into a binary bit stream and sends the stream to the Forwarder 143/243 through the Network 131/231. The user end 101/201 sends back the playback status to the ARS Controller 141/242. The playback status is also sent to the Forwarder 243 in the system using TCP. The ARS Controller can also use reinforcement learning tools to train and optimize the ABR algorithm. The function and operation of training the ABR algorithm in the ARS Controller is illustrated in FIG. 3 and will be discussed below. Note that the Service Gateways 121/221 shown in the FIGS. 1 and 2 are logical functional modules, which may be implemented in the user end 101/201 at the viewing devices, or with the streaming server 111/211 at the servers, or implemented in edge servers, such as in the base station in Mobile Edge Computing (MEC) scenarios.

In the ARS system using UDP, as shown in FIG. 1, a Network Address Translation (NAT) protocol 142 (such as Interactive Connectivity Establishment (ICE)) is utilized to perform the traversal of UDP address in the phase of session establishment. In the ARS system using TCP, as shown in FIG. 2, the ARS system also includes a Frame Buffer 241 to manage the real-time video streaming sent to the user end through the Forwarder 243.

As shown in FIG. 3, ARS systems can employ reinforcement learning tool to train optimal ABR algorithm in the ARS Controller in FIGS. 1 and 2. At a given time t, each user end serves as an agent 301/302/303, which takes an action Aₜ (i.e., streaming at a certain bitrate) in the environment 321. Multi-agent scheme allows faster training of the ABR algorithms in ARS. Unlike the HTTP-based video streaming systems where each chunk of video data is encoded at a coarse-grained discrete bitrate in advance, in an embodiment of ARS, the bitrate adaptation in the real-time video streaming service is of a different design. The action set of ARS is constructed by varying degrees of bitrate increase or decrease. For example, {−4000, −2000, −1000, −500, +0, +100, +200, +300, +400}kbps and {×0.7, ×0.8, ×0.9, ×(1−packetLossRate), +0, +100, +200, +300, +400}kbps can both serve as action sets in ARS. The action set construction follows the principle of Additive Increase Multiplicative Decrease (AIMD) distribution, which complies with AIMD in TCP congestion control. AIMD increases the bitrate linearly when the network condition is good but reduces the bitrate exponentially when a network congestion takes place. The range and grain of this action set can be adjusted according to the average bandwidth of the user's network and other practical factors.

Two categories of states Sₜ including the network QoS (such as the round-trip time (RTT), the received bitrate, the packet loss rate, the retransmission packet count) and the playback status (such as received frame rate, maximum received frame interval, and minimum received frame interval) are provided to the agent 301/302/303/304 by the environment 321.

Specifically, RTT is calculated by combining transmission delay (which is derived by dividing the current sending bitrate by the current throughput) and queuing delay (which is derived by considering loss packet retransmission), propagation delay and processing delay. The packet loss rate is calculated during video packet transmission according to the frame size and the current throughput. Due to the packet loss, retransmission packets are repeatedly sent from the Streaming Server to the user end until they are received or overdue, which is also counted by ARS. And the received frame rate and the maximum/minimum frame interval are inferred based on the packet receiving condition. These status observations are further normalized to the range [−1,1] to speed up the training process.

The environment 321 also provides a reward Rₜ to the agent, which the agent 301/302/303/304 is based on to decide next action Aₜ₊₁ at the time t+1, to keep increasing the reward. ARS balances a variety of QoE goals to determine the reward Rₜ. As an example, Equation (1) below represents an ARS QoE matrices considering the past N grounds for a real-time video streaming.

QoE=Σₜ₌₁^{N}αₜq(rₜ)−μΣₜ₌₁^{N}αₜFₜ−kΣₜ₌₁^{N}αₜ|q(rₜ)−q(rₜ₋₁)|−ιΣₜ₌₁^{N}αₜLₜ (1)

In Equation (1), within the first term, rₜ represents the sending bitrate in the near t ground and q(rₜ) maps that sending bitrate to the quality perceived by a user. The choice of rₜ could be linear, logarithmic or other functions. The second term Fₜ represents the freezing time that results from streaming the video in the near t ground at bitrate rₜ. The third term penalizes the changes in video quality in favor of smoothness, and the final term penalizes the end-to-end interaction latency at bitrate rₜ. In other words, the QoE or reward can be computed by subtracting the freezing penalty, the smoothness penalty and the latency penalty from the bitrate utility. μ, k and ι denote for freezing, smoothness, and latency penalty factor respectively. The parameter αₜ is introduced as a temporal significance factor to place QoE factors in a time domain for reward computation.

In another embodiment, apart from the regular agents 301/302/303, a central agent 304 is included to handle the tuple (Sₜ, Aₜ, Rₜ) received from the regular agents and to compute updated network parameters via a gradient descent method. By jointly considering the output gradients produced by these regular agents in the central agent 304, such as using averaging operation, the oscillation of reward curve over epoch decreases, making the control policy faster to converge. With the result gradient, the parameters or weights in the neural network are updated and then passed to the regular agents 301/302/303 to update their own networks.

In a further embodiment, ARS supports training of the ABR algorithms both online and offline. In the online scenario, training could take place using actual video streaming user ends. Using a pre-trained offline model as a priori, ARS enables the ABR algorithms to be updated periodically as new actual data arrives even after the algorithms have been deployed in the real environment. By collecting real environment statuses, it makes ARS more effective to train a specific ABR algorithm that best suits the user's actual network conditions. Each specific ABR algorithm could be individually trained based on its underlying network and used for that underlying network dedicatedly to improve the accuracy and performance of ARS.

Normally, ABR algorithms can only be trained and updated until all video packets are completely streamed, resulting in very slow training speed. To train a general ABR algorithm applicable to all users, it calls for more training work on diverse types of network environment and more training samples and time. In addition, it incurs extra computational overhead for the devices in which ARS is deployed, either at the server side or the user end side. To overcome these constraints, in one embodiment, training ABR algorithms in a simulation environment offline that closely models the dynamics of video streaming with real client applications is performed to further accelerate the training speed. The training set used for simulation is obtained by simulating real video streaming processes to get state observations (i.e., the network QoS and the playback status) over various patterns of network environment. For example, a corpus of network throughput traces is first created by combining several public bandwidth datasets (i.e., FCC, Norway, 3G/HSDPA, and 4G/Belgium), and these network throughput traces are then used to simulate the actual network conditions. The network throughput traces are down sampled to an augment sample size. To make the simulation faithful to the actual environment, ARS uses real video sequences for encoding at diverse fine-grained bitrates. By streaming these videos over simulated networks with network throughput traces closely following the actual network environment, the network QoS parameters and playback status can be obtained.

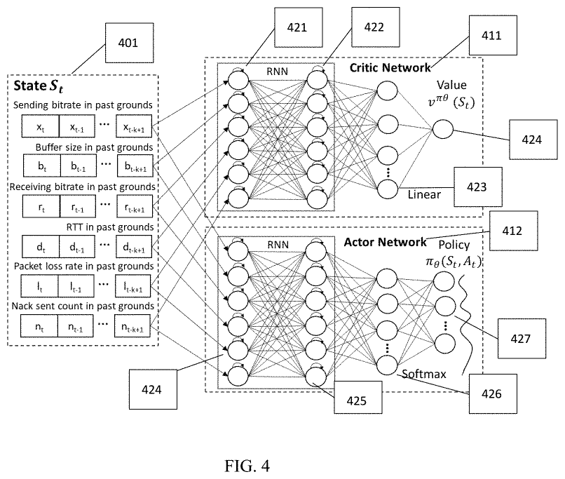

In another embodiment, ARS also supports a variety of different training algorithms to train the agent in an abstract reinforcement learning framework. Taking A3C as an example, which is a state-of-the-art actor-critic method involving training two neural networks, the basic training algorithm of ARS using an A3C network in the agent is illustrated in FIG. 4. After each streaming ground, ARS's agent takes state inputs Sₜ=(\vec{xₜ}, \vec{bₜ}, \vec{rₜ}, \vec{dₜ}, \vec{lₜ}, \vec{nₜ}) to its neural networks. \vec{xₜ} is the sending bitrate for the past k grounds; \vec{bₜ} is the buffer size for the past k grounds, which represents the proportion of the received frames over the sending frames; rₜ is the received bitrate corresponding to \vec{xₜ}; \vec{dₜ} represents the RTT consisting of the random propagation time, the transmission time, the processing time and the queuing time; \vec{lₜ} represents the packet loss rate counted by excluding the successful retransmitted packets using the NACK scheme, in which the NACK sent count is denoted as \vec{nₜ}. \vec{lₜ} and \vec{nₜ} are used for UDP based video streaming. For TCP based video streaming, \vec{lₜ} and tare substituted by \vec{aₜ} and \vec{lₜ}, which respectively represent the maximum and minimum frame interval during a ground.

In a further embodiment, the agent selects actions based on a policy, defined as a probability distribution over actions π: π(Sₜ, Aₜ)→[0,1]. π(Sₜ, Aₜ) is the probability that action Aₜ is taken in state Sₜ. ARS can use a neural network (NN) including a convolutional neural network (CNN) and recurrent neural network (RNN) to generate the policy with a manageable number of an adjustable parameter, θ, as the policy parameter. The actor network 412 in FIG. 4 depicts how ARS uses an NN to generate an ABR policy. Since not only the current but also the past state observations are collected, RNN is supported by ARS to enable exploration of network features in the time domain.

An example of RNN framework used in ARS comprises five layers: Input layer 401, where the states are reshaped with temporal components of each state type that serve as another dimension; First RNN layer 421/424, where the tensor from the last layer is passed to a GRU network with the time step equaling to the count of past grounds considered. All the sequential results are passed to the next layer; Second RNN layer 422/425, where the sequential tensor from the last layer is passed to another GRU network and only the latest results are passed to the next layer; Full connection layer 423/426, where the tensor from the last layer is passed into a dense layer with full connection; Output layer 424/427, a full-connection layer, where the tensor from the last layer is reshaped to a new tensor with the dimension (1, ActionDimension), using the softmax activation function 427 in the actor network 412 or to a tensor with the dimension (1,1) using the linear activation function 424 in the critic network 411.

After applying each action, the simulated environment provides the agent (such as the agents 301/302/303/304 in FIG. 3) with a reward Rₜ. The primary goal of the ARS agent is to maximize the expected cumulative reward that it receives from the environment. And the reward is set to reflect the performance of each streaming ground according to the QoE matrices ARS intends to optimize as discussed above. The example of the actor-critic algorithm used by ARS to train its policy is a policy gradient method. Policy gradient methods estimate the gradient of the expected total reward by observing the trajectories of executions obtained by following the policy. The role of the critic network 411 in FIG. 4 is to learn an estimate of ν^{π}^{_{θ}}(S) from empirically observed rewards. The standard Temporal Difference method is used to train the critic network parameters. To ensure that the ARS agent explores the action space adequately during training to discover good policies, an entropy regularization term is included to the agent's updated rule to encourage the exploration.

Upon training and optimizing an ABR algorithm, it can be deployed in an ARS system. Besides implementing in the service gateway (which can be implemented in any suitable devices, such as edge servers) as shown in FIGS. 1 and 2, the trained ABR algorithm can also be deployed at the user end 101/201 or at the streaming servers 111/211. On one hand, ARS could be enabled directly at the user end as all the state observations could also be collected by the user end. With trained ABR algorithm by ARS, the bitrate adaptation action can be made by the user end and transmitted to the Streaming Server 111/211 to adjust the sending bitrate. The difference is that the workload (both for training and operating) is transferred from the service gateway to the user end, which incurs extra burden and process delay to the user end. On the other hand, ARS could also be enabled at the streaming server side 111/211, which collects the state observation from the end user, makes decisions on the bitrate for the next time slot, and then adjusts the sending bitrate. In this scenario, the training and operating can be conducted at the server side.

By using DRL-based ARS to handle ABR control in real-time video streaming systems, it optimizes its policy for different network characteristics and QoE metrices directly from user QoE, without using assumptions on fixed heuristics or inaccurate network models or patterns. Considering both Network QoS factors and playback statuses using the DRL technology, ARS achieves higher performance in term of user QoE, compared to existing closed-form ABR algorithms.

It should be noted that one or more of the methods described herein may be implemented in and/or performed using any DRL Network algorithm, such as DQN (Deep Q-learning Network), REINFORCE, Q-learning and A3C (Asynchronous advantage actor-critic). And the Neural Network (NN) to be used in the ARS systems is not limited to the form and operation discussed herein.

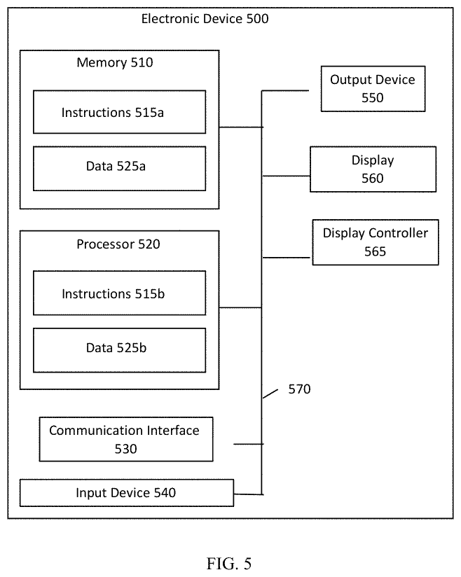

FIG. 5 illustrates various components that may be utilized in an electronic device 500. The electronic device 500 may be implemented as one or more of the electronic devices (e.g., electronic devices 100, 111, 121, 201, 211, 221, 311, 314, 315, 304, 321) described previously.

The electronic device 500 includes a processor 520 that controls operation of the electronic device 500. The processor 520 may also be referred to as a CPU. Memory 510, which may include both read-only memory (ROM), random access memory (RAM) or any type of device that may store information, provides instructions 515a (e.g., executable instructions) and data 525a to the processor 520. A portion of the memory 510 may also include non-volatile random access memory (NVRAM). The memory 510 may be in electronic communication with the processor 520.

Instructions 515b and data 525b may also reside in the processor 520. Instructions 515b and data 525b loaded into the processor 520 may also include instructions 515a and/or data 525a from memory 610 that were loaded for execution or processing by the processor 520. The instructions 515b may be executed by the processor 520 to implement the systems and methods disclosed herein.

The electronic device 500 may include one or more communication interfaces 530 for communicating with other electronic devices. The communication interfaces 530 may be based on wired communication technology, wireless communication technology, or both. Examples of communication interfaces 530 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, a wireless transceiver in accordance with 3^{rd} Generation Partnership Project (3GPP) specifications and so forth.

The electronic device 500 may include one or more output devices 550 and one or more input devices 540. Examples of output devices 550 include a speaker, printer, etc. One type of output device that may be included in an electronic device 500 is a display device 560. Display devices 560 used with configurations disclosed herein may utilize any suitable image projection technology, such as a cathode ray tube (CRT), liquid crystal display (LCD), light-emitting diode (LED), gas plasma, electroluminescence or the like. A display controller 565 may be provided for converting data stored in the memory 510 into text, graphics, and/or moving images (as appropriate) shown on the display 560. Examples of input devices 540 include a keyboard, mouse, microphone, remote control device, button, joystick, trackball, touchpad, touchscreen, lightpen, etc.

The various components of the electronic device 500 are coupled together by a bus system 570, which may include a power bus, a control signal bus and a status signal bus, in addition to a data bus. However, for the sake of clarity, the various buses are illustrated in FIG. 5 as the bus system 570. The electronic device 500 illustrated in FIG. 5 is a functional block diagram rather than a listing of specific components.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods or approaches described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

1. A system for training adaptive real-time streaming using deep reinforcement learning (DRL), comprising:
one or more agents,
one or more environment units,
and one or more deep reinforcement learning networks,
wherein each agent takes an action towards said one or more environment units at time t, the action including transmitting video data at a bitrate; each agent receives one or more network states from said one or more environment units, said network states including one or more network quality of service (QoS) factors and one or more playback statuses; each agent takes another action at time t+1 based on a reward received from said one or more environment units; and
wherein said one or more environment units receive the action from each agent, provide said network states to each agent, and provide said reward to each agent; said one or more environment units determining said reward by balancing multiple network quality of experience (QoE) requirements.

2. The system of claim 1, wherein said deep reinforcement learning networks are deployed in said one or more agents to receive said network states, make determinations on said actions and update said one or more agents' networks.

3. The system of claim 1, wherein said network QoS factors comprise round-trip time (RTT), a received bitrate, a packet loss rate, retransmission packet count.

4. The system of claim 1, wherein said playback statuses comprise a received frame rate, a maximum received frame interval, and a minimum received frame interval.

5. The system of claim 1, wherein said multiple QoE requirements include maximizing the video quality by utilizing highest average bitrate, minimizing video freezing events, maintaining the video quality smoothness, and minimizing the video latency.

6. The system of claim 1, wherein the reward is calculated by subtracting a freezing penalty, a smoothness penalty and a latency penalty from a bitrate utility.

7. The system of claim 1, wherein the action is taken at a frequency to enable fast reaction to a change in said network states, including one action per second or one action per group of picture.

8. The system of claim 1, wherein the one or more agents comprise one or more regular agents and one or more central agents, wherein the central agent receives information from one or more regular agents, computes one or more network parameters based on the information, and passes said network parameters to said one or more regular agents for updating their networks, wherein the information including the network states, the action, and the reward.

9. The system of claim 1, where in a simulation is constructed to provide network states to train the deep reinforcement learning networks offline.
